(19) United States
(12) Patent Application Publication
(10) Pub. No.: US 2009/0207315 A1
(43) Pub. Date: Aug. 20, 2009

(54) IMAGE SIGNAL PROCESSING APPARATUS, IMAGE SIGNAL PROCESSING METHOD, AND PROGRAM

(75) Inventors: Masaru Ikeda, Kanagawa (JP); Tetsujiro Kondo, Tokyo (JP); Kenji Takahashi, Kanagawa (JP); Tomoyuki Otsuki, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/372,167

(22) Filed: Feb. 17, 2009

(30) Foreign Application Priority Data
Feb. 20, 2008 (JP) 2008-038334

(51) Int. Cl. H04N 5/14; H04N 7/12

(52) U.S. Cl. 348/699; 348/700; 348/E05.001; 375/240.16; 375/E07.104

(57) ABSTRACT

An image signal processing apparatus detects a motion vector between two temporally successive frames, and includes a detection device, a calculation device, and an arithmetic device. The detection device is configured to detect the motion vector in pixel blocks between the two frames, and output an evaluation value, which represents the degree of correspondence between the two frames in the pixel blocks provided in the two frames, and which is calculated in the process of detecting the motion vector. The calculation device is configured to calculate an activity value, which represents the degree of variation in pixel value in the frame, on the basis of the direction of the detected motion vector. The arithmetic device is configured to perform an arithmetic operation to obtain an accuracy value, which represents the degree of reliability of the detected motion vector, on the basis of the evaluation value and the activity value.

### CROSS REFERENCES TO RELATED APPLICATIONS

The present invention contains subject matter related to Japanese Patent Application JP 2008-038334 filed in the Japanese Patent Office on Feb. 20, 2008, the entire contents of which are incorporated herein by reference.

### BACKGROUND OF THE INVENTION

1. Field of the Invention

The present invention relates to an image signal processing apparatus, an image signal processing method, and a program, particularly to an image signal processing apparatus, an image signal processing method, and a program preferable in detecting a motion vector between two frames forming a moving image and performing a predetermined process on the basis of the detected motion vector.

2. Description of the Related Art

There has been image signal processing which detects a motion vector between two frames forming a moving image and is performed in accordance with the detected motion vector in such processes as a process of compressing and coding a moving image, a process of correcting blurring in a moving image caused by hand shake when the image is taken, a process of detecting a scene change, and a process of estimating the motion of the background, for example. In some cases, the image signal processing does not directly rely on and use the detected motion vector but determines the reliability of the detected motion vector, and determines whether or not to use the detected motion vector on the basis of the determination result.

Indicators representing the reliability of the motion vector include an evaluation value calculated in the process of detecting the motion vector and a block activity value of a pixel block corresponding to the detected motion vector.

Herein, the evaluation value calculated in the process of detecting the motion vector corresponds to the sum of the absolute values of the differences in pixel value between pixel blocks provided in a base frame and pixel blocks provided in a reference frame, which is obtained in the calculation of the motion vector in accordance with a block matching method, for example. That is, the smaller the evaluation value of the detected motion vector is, the more reliable the motion vector is determined to be.

Further, the block activity value of a pixel block is an indicator representing the complexity of the image of the pixel block. Specifically, as illustrated in FIG. 1, the pixels included in a pixel block are sequentially selected as the target pixel, and an activity value of the target value (the average value of the absolute values of the differences in pixel value between the target pixel and eight pixels adjacent to the target pixel in eight directions of upper, lower, left, right, and diagonal directions, i.e., the average value of directional activity values) is calculated. Then, the total sum of the activity values of all of the pixels included in the pixel block is used as the block activity value.

If the pixel block is formed by 4×8 pixels, as illustrated in FIG. 1, for example, the block activity value corresponds to the total sum (the integrated value) of the activity values (each of which is the average value of the absolute values of the differences in pixel value in eight directions) of thirty-two pixels. Therefore, the larger the block activity value is, the more complicated the image is, and the less likely an error is to occur in the matching according to the block matching method or the like. Accordingly, the larger the block activity value of the detected motion vector is, the more reliable the motion vector is determined to be.

Further, the evaluation value calculated in the process of detecting the motion vector and the block activity value of the pixel block corresponding to the detected motion vector have a statistical relationship as illustrated in FIG. 2. A method has been proposed which calculates an evaluation value representing the reliability of the motion vector (hereinafter referred to as the motion vector accuracy value) by using the relationship of FIG. 2 (see Japanese Unexamined Patent Application Publication No. 2005-301984).

In the statistical relationship illustrated in FIG. 2, it is assumed that the larger the block activity value is, the more reliable the detected motion vector is (the larger the motion vector accuracy value is). It is further assumed that the smaller the evaluation value is, the more reliable the detected motion vector is.

FIG. 3 illustrates an example of the configuration of a motion vector detection apparatus which detects the motion vector and calculates the motion vector accuracy value on the basis of the statistical relationship illustrated in FIG. 2.

The motion vector detection apparatus 10 is configured to include a frame memory 11, a motion vector detection unit 12, a block activity value calculation unit 13, a threshold value determination unit 14, an accuracy value calculation unit 15, and a reliability determination unit 16.

The frame memory 11 delays sequentially input image signals by one frame. The motion vector detection unit 12 detects the motion vector between two frames. The block activity value calculation unit 13 calculates the block activity value for each of the pixel blocks of the respective frames. The threshold value determination unit 14 compares the block activity value with a predetermined threshold value. The accuracy value calculation unit 15 calculates the motion vector accuracy value on the basis of the evaluation value and the block activity value. The reliability determination unit 16 determines on the basis of the motion vector accuracy value whether or not the motion vector is reliable.

The motion vector detection unit 12 divides each of the frames of the image signals into the pixel blocks, and detects the motion vector for each of the pixel blocks. Then, the motion vector detection unit 12 supplies the detected motion vector to a not-illustrated subsequent stage, and supplies the evaluation value calculated in the process of detecting the motion vector to the accuracy value calculation unit 15.

Meanwhile, the block activity value calculation unit 13 divides each of the frames of the image signals into the pixel blocks, and calculates and outputs the block activity value to the threshold value determination unit 14 and the accuracy value calculation unit 15.

The threshold value determination unit 14 determines whether or not the block activity value is equal to or smaller than a predetermined threshold value, and outputs the determination result to the reliability determination unit 16.

The accuracy value calculation unit 15 calculates the motion vector accuracy value VC on the basis of the equation VC=1−(evaluation value/block activity value), and outputs the calculated motion vector accuracy value VC to the reliability determination unit 16.

On the basis of the motion vector accuracy value VC, the reliability determination unit 16 determines whether or not the motion vector detected by the motion vector detection unit 12 is reliable. The reliability determination unit 16 does not rely only on the motion vector accuracy value VC. Thus, if it is found from the determination result by the threshold value determination unit 14 that the block activity value is equal to or smaller than the threshold value, the reliability determination unit 16 determines that the detected motion vector is unreliable.

### SUMMARY OF THE INVENTION

According to the motion vector detection apparatus 10 of FIG. 3, if a pixel block includes a part of a linear edge of a subject, as illustrated in FIG. 4, for example, the block activity value is increased in spite of a tendency for the motion vector to be erroneously detected, and the motion vector accuracy value is increased. In some cases, therefore, an erroneously detected motion vector is erroneously determined to be reliable.

Further, according to the motion vector detection apparatus 10 of FIG. 3, if the block activity value is equal to or smaller than the threshold value, the motion vector is uniformly determined to be unreliable. In fact, however, there are many cases in which an accurate motion vector has been detected even if the block activity value is equal to or smaller than the threshold value.

The present invention has been made in light of the above-described circumstances so as to be able to accurately determine the reliability of the detected motion vector.

An image signal processing apparatus according to a first embodiment of the present invention detects a motion vector between two temporally successive frames, and includes: detection means for detecting the motion vector in pixel blocks between the two frames, and outputting an evaluation value, which represents the degree of correspondence between the two frames in the pixel blocks provided in the two frames, and which is calculated in the process of detecting the motion vector; calculation means for calculating an activity value, which represents the degree of variation in pixel value in the frame, on the basis of the direction of the detected motion vector; and arithmetic means for performing an arithmetic operation to obtain an accuracy value, which represents the degree of reliability of the detected motion vector, on the basis of the evaluation value and the activity value.

The calculation means may calculate plural types of activity values, which represent the degree of variation in pixel value in the frame, on the basis of the direction of the detected motion vector.

The image signal processing apparatus according to the first embodiment of the present invention may further include determination means for determining the reliability of the detected motion vector on the basis of the calculated activity value.

An image signal processing method according to the first embodiment of the present invention is performed by an image signal processing apparatus which detects a motion vector between two temporally successive frames. The image signal processing method includes the steps of: detecting the motion vector in pixel blocks between the two frames; outputting an evaluation value, which represents the degree of correspondence between the two frames in the pixel blocks provided in the two frames, and which is calculated in the process of detecting the motion vector; calculating an activity value, which represents the degree of variation in pixel value in the frame, on the basis of the direction of the detected motion vector; and performing an arithmetic operation to obtain an accuracy value, which represents the degree of reliability of the detected motion vector, on the basis of the evaluation value and the activity value.

A program according to the first embodiment of the present invention controls an image signal processing apparatus which detects a motion vector between two temporally successive frames. The program causes a computer of the image signal processing apparatus to perform processing including the steps of: detecting the motion vector in pixel blocks between the two frames; outputting an evaluation value, which represents the degree of correspondence between the two frames in the pixel blocks provided in the two frames, and which is calculated in the process of detecting the motion vector; calculating an activity value, which represents the degree of variation in pixel value in the frame, on the basis of the direction of the detected motion vector; and performing an arithmetic operation to obtain an accuracy value, which represents the degree of reliability of the detected motion vector, on the basis of the evaluation value and the activity value.

The first embodiment of the present invention detects a motion vector in pixel blocks between two frames, and outputs an evaluation value, which represents the degree of correspondence between the two frames in the pixel blocks provided in the two frames, and which is calculated in the process of detecting the motion vector. Further, the first embodiment of the present invention calculates an activity value, which represents the degree of variation in pixel value in the frame, on the basis of the direction of the detected motion vector, and performs an arithmetic operation to obtain an accuracy value, which represents the degree of reliability of the detected motion vector, on the basis of the evaluation value and the activity value.

An image signal processing apparatus according to a second embodiment of the present invention detects a motion vector between two temporally successive frames, and includes detection means for detecting the motion vector in pixel blocks between the two frames, and calculation means for calculating an activity value, which represents the degree of variation in pixel value in the frame, on the basis of the direction of the detected motion vector.

The calculation means may calculate plural types of activity values, which represent the degree of variation in pixel value in the frame, on the basis of the direction of the detected motion vector.

An image signal processing method according to the second embodiment of the present invention is performed by an image signal processing apparatus which detects a motion vector between two temporally successive frames. The image signal processing method includes the steps of: detecting the motion vector in pixel blocks between the two frames; and calculating an activity value, which represents the degree of variation in pixel value in the frame, on the basis of the direction of the detected motion vector.

A program according to the second embodiment of the present invention controls an image signal processing apparatus which detects a motion vector between two temporally successive frames. The program causes a computer of the image signal processing apparatus to perform processing including the steps of: detecting the motion vector in pixel blocks between the two frames; and calculating an activity value, which represents the degree of variation in pixel value in the frame, on the basis of the direction of the detected motion vector.

The second embodiment of the present invention detects a motion vector in pixel blocks between two frames, and calculates an activity value, which represents the degree of variation in pixel value in the frame, on the basis of the direction of the detected motion vector.

According to the first embodiment of the present invention, it is possible to accurately determine the reliability of the detected motion vector.

According to the second embodiment of the present invention, it is possible to acquire the activity value which represents the variation in pixel value, and which serves as an indicator for determining the reliability of the detected motion vector.

### BRIEF DESCRIPTION OF THE DRAWINGS

FIG. 1 is a diagram for explaining a method of calculating a block activity value;

FIG. 2 is a diagram illustrating the relationship between an evaluation value and the block activity value;

FIG. 3 is a block diagram illustrating an example of the configuration of an existing motion vector detection apparatus;

FIG. 4 is a diagram for explaining an example in which a motion vector is erroneously detected in spite of a large block activity value;

FIG. 5 is a block diagram illustrating a configuration example of a motion vector detection apparatus applied with an embodiment of the present invention;

FIG. 6 is a block diagram illustrating a detailed configuration example of the activity value calculation unit of FIG. 5;

FIGS. 7A to 7D are diagrams for explaining the directions of the motion vector;

FIG. 8 is a diagram illustrating a calculation example of a first activity value;

FIGS. 9A to 9D are diagrams for explaining the directions of the motion vector;

FIGS. 10A to 10D are diagrams for explaining the directions of the motion vector;

FIG. 11 is a diagram illustrating a calculation example of a second activity value;

FIG. 12 is a flowchart for explaining a motion vector detection process; and

FIG. 13 is a flowchart describing in detail Step S2 of FIG. 12.

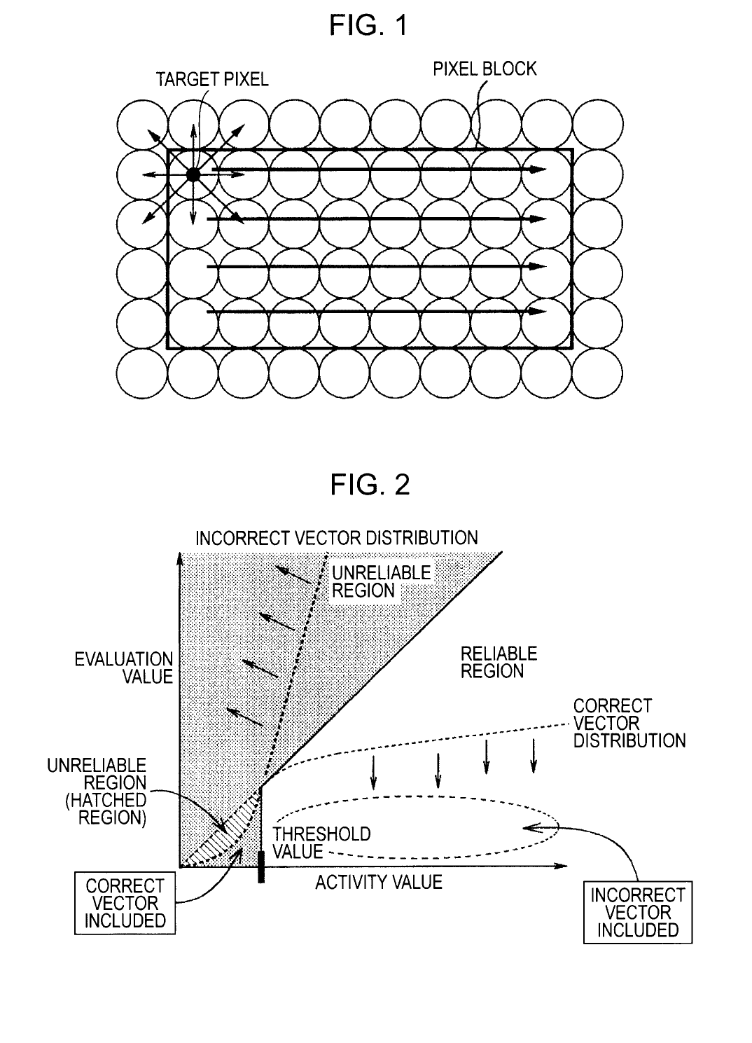

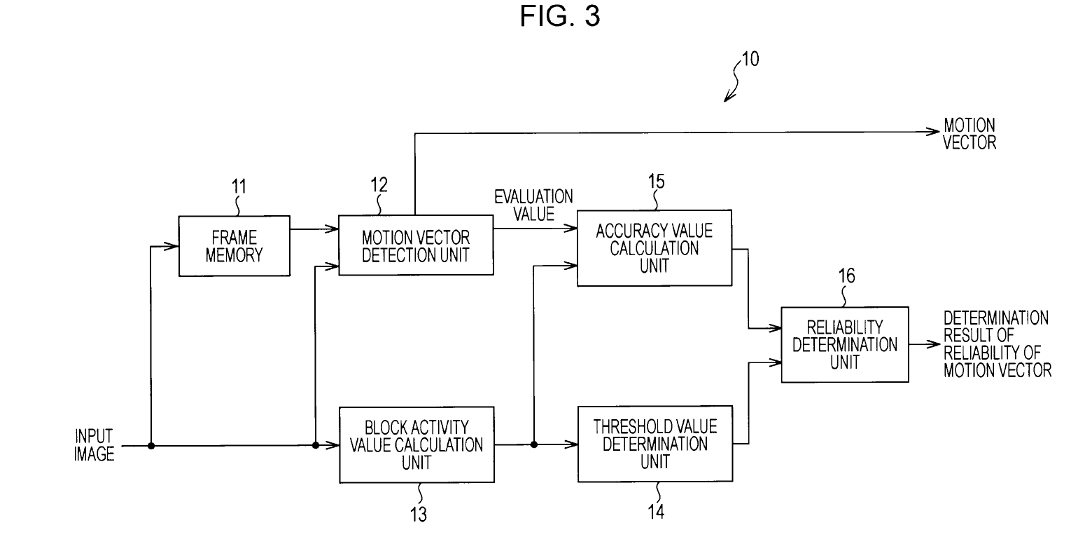

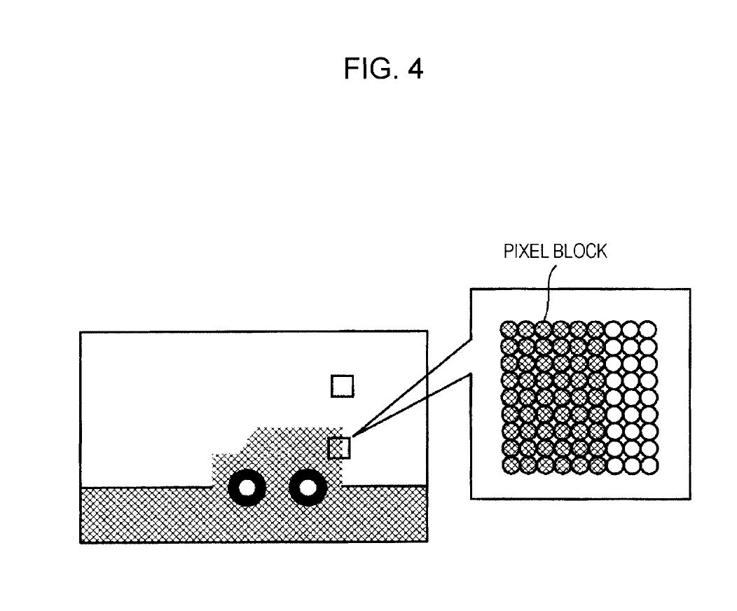

### DESCRIPTION OF THE PREFERRED EMBODIMENTS

Specific embodiments applied with the present invention will be described in detail below with reference to the drawings.

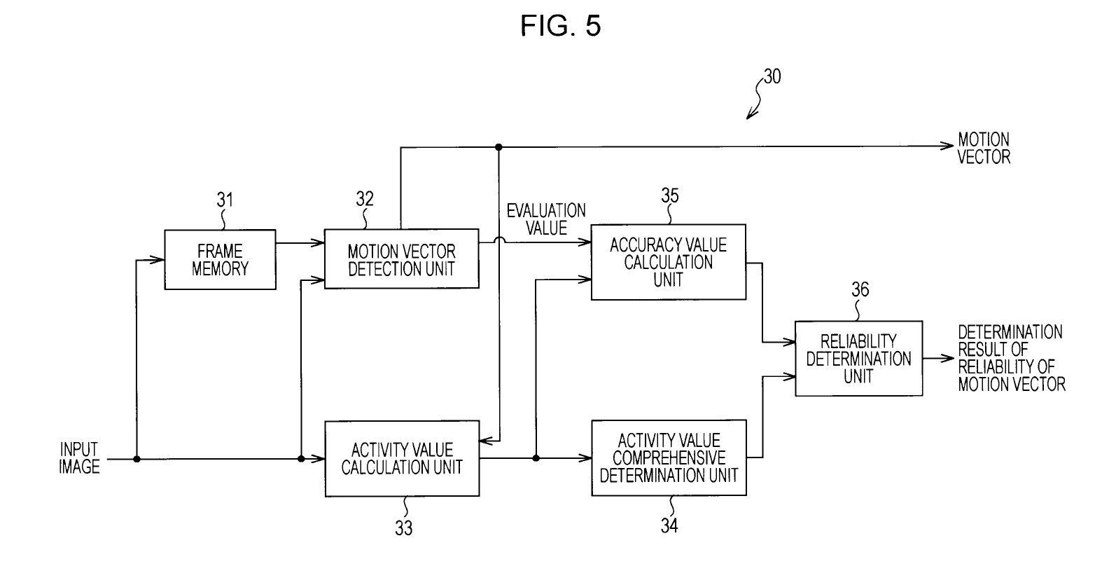

FIG. 5 illustrates a configuration example of a motion vector detection apparatus, which is an embodiment of the present invention. The motion vector detection apparatus 30 divides each of the frames of image signals input by a preceding stage into pixel blocks, detects the motion vector for each of the pixel blocks, and determines the reliability of the detected motion vector.

The motion vector detection apparatus 30 is configured to include a frame memory 31, a motion vector detection unit 32, an activity value calculation unit 33, an activity value comprehensive determination unit 34, an accuracy value calculation unit 35, and a reliability determination unit 36.

The frame memory 31 delays the sequentially input image signals by one frame. The motion vector detection unit 32 detects the motion vector between two frames. The activity value calculation unit 33 calculates the block activity value and so forth for each of the pixel blocks of the respective frames. The activity value comprehensive determination unit 34 makes a comprehensive determination of the calculated block activity value and so forth. The accuracy value calculation unit 35 calculates the motion vector accuracy value on the basis of the evaluation value and the block activity value, for example. The reliability determination unit 36 determines on the basis of the motion vector accuracy value whether or not the motion vector is reliable.

The frame memory 31 supplies the sequentially input image signals to the motion vector detection unit 32 by delaying the signals by one frame. Therefore, the motion vector detection unit 32 is supplied with two chronologically successive frames by the frame memory 31 and the preceding stage of the motion vector detection apparatus 30.

The motion vector detection unit 32 detects the motion vector by employing the block matching method, for example. Specifically, the motion vector detection unit 32 sets a base frame to be one of the two frames simultaneously supplied by the frame memory 31 and the preceding stage of the motion vector detection apparatus 30, divides the frames into the pixel blocks, and detects the motion vector for each of the pixel blocks. Then, the motion vector detection unit 32 supplies the detected motion vector to a not-illustrated subsequent stage and the activity value calculation unit 33, and outputs the evaluation value calculated in the process of detecting the motion vector to the accuracy value calculation unit 35. The motion vector detection unit 32 may alternatively be configured to detect the motion vector in accordance with a method other than the block matching method (e.g., a gradient method), for example. Further, the frame memory 31 may be configured to delay the image signals by a few frames such that the motion vector detection unit 32 detects the motion vector between two frames temporally apart from each other by a few frames.

The activity value calculation unit 33 divides each of the frames of the image signals into the pixel blocks, and calculates and outputs the block activity value to the activity value comprehensive determination unit 34 and the accuracy value calculation unit 35. Further, the activity value calculation unit 33 calculates and outputs a first activity value, a first pixel count value, a second activity value, and a second pixel count value, which will be described later, to the activity value comprehensive determination unit 34.

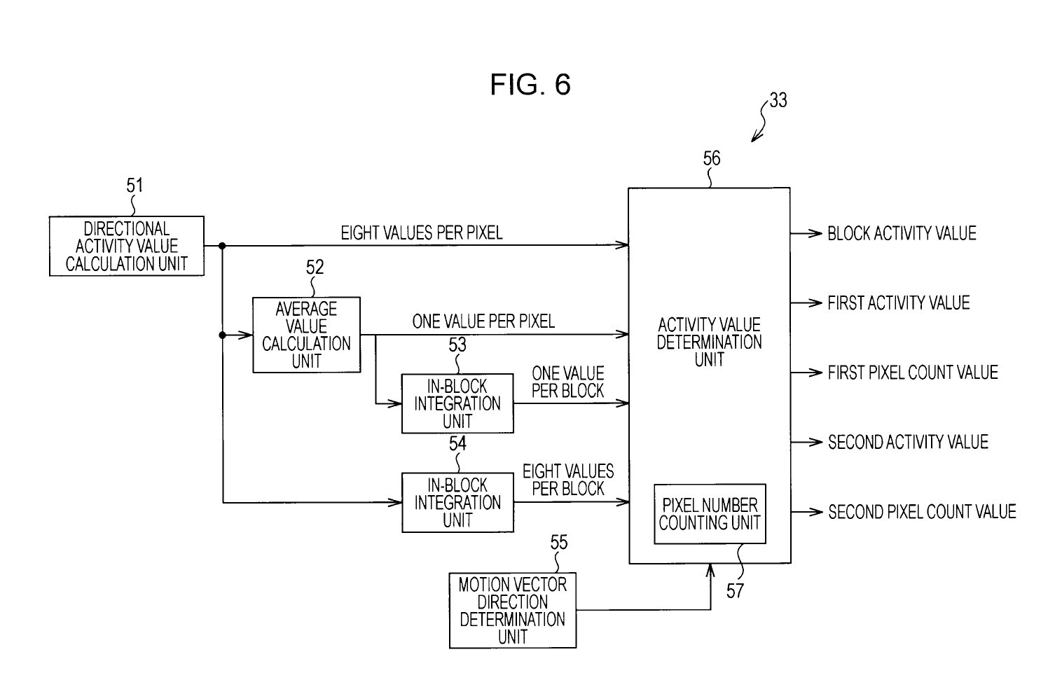

Herein, a detailed configuration example of the activity value calculation unit 33 will be described with reference to FIG. 6.

The activity value calculation unit 33 is configured to include a directional activity value calculation unit 51, an average value calculation unit 52, an in-block integration unit 53, an in-block integration unit 54, a motion vector direction determination unit 55, and an activity value determination unit 56.

The directional activity value calculation unit 51 calculates the directional activity values in eight directions for each of the pixels included in a pixel block. The average value calculation unit 52 calculates the existing activity value by averaging the directional activity values in eight directions calculated for each of the pixels. The in-block integration unit 53 calculates the in-block total sum (integrated value) of the existing activity values calculated for the respective pixels included in the pixel block. The in-block integration unit 54 integrates (adds up), for the respective eight directions in the pixel block, the directional activity values in eight directions calculated for the respective pixels. The motion vector direction determination unit 55 determines the direction of the detected motion vector. On the basis of the calculation results by the directional activity value calculation unit 51 to the in-block integration unit 54, the activity value determination unit 56 generates the block activity value, the first activity value, the first pixel count value, the second activity value, and the second pixel count value.

The directional activity value calculation unit 51 sequentially selects the respective pixels of the pixel block as the target pixel. Then, the directional activity value calculation unit 51 calculates, as the directional activity values in eight directions, the absolute values of the differences in pixel value between the target pixel and eight pixels adjacent to the target pixel in eight directions of upper, lower, left, right, and diagonal directions, and outputs the calculated directional activity values in eight directions to the activity value determination unit 56. Therefore, the directional activity value calculation unit 51 outputs eight values for each pixel.

The average value calculation unit 52 calculates the average value of the directional activity values in eight directions calculated for each of the pixels (the existing activity value), and outputs the calculated average value to the in-block integration unit 53 and the activity value determination unit 56. Therefore, the average value calculation unit 52 outputs one value for each pixel.

The in-block integration unit 53 calculates the in-block total sum (integrated value) of the existing activity values calculated for the respective pixels of the pixel block, i.e., calculates the block activity value, and outputs the calculated block activity value to the activity value determination unit 56. Therefore, the in-block integration unit 53 outputs one value for each pixel block.

The in-block integration unit 54 integrates (adds up), for the respective eight directions in the pixel block, the directional activity values in eight directions calculated for the respective pixels, and outputs the integrated values to the activity value determination unit 56. Therefore, the in-block integration unit 54 outputs eight values for each pixel block.

The motion vector direction determination unit 55 determines the direction of the motion vector detected by the motion vector detection unit 32, and outputs the determination result to the activity value determination unit 56.

The activity value determination unit 56 directly outputs the output by the in-block integration unit 53 to the subsequent stage as the block activity value.

Further, the activity value determination unit 56 determines the first activity value on the basis of the determination result of the direction of the motion vector and the output by the in-block integration unit 54, and outputs the determined first activity value to the subsequent stage.

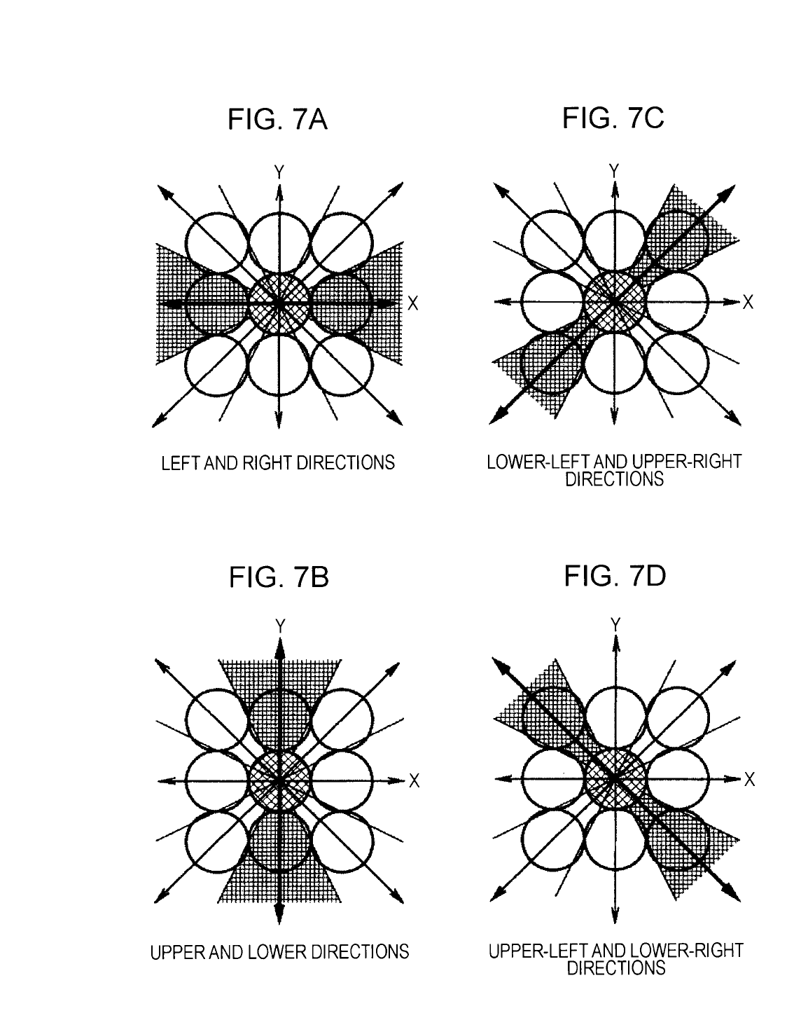

Specifically, if the direction of the motion vector is included in the left and right directions illustrated in FIG. 7A, the activity value determination unit 56 performs comparison between the value located in the left direction and the value located in the right direction among the eight values output by the in-block integration unit 54, and determines the larger one of the two values to be the first activity value.

If the direction of the motion vector is included in the upper and lower directions illustrated in FIG. 7B, the activity value determination unit 56 performs comparison between the value located in the upper direction and the value located in the lower direction among the eight values output by the in-block integration unit 54, and determines the larger one of the two values to be the first activity value.

If the direction of the motion vector is included in the lower-left and upper-right directions illustrated in FIG. 7C, the activity value determination unit 56 performs comparison between the value located in the lower-left direction and the value located in the upper-right direction among the eight values output by the in-block integration unit 54, and determines the larger one of the two values to be the first activity value.

If the direction of the motion vector is included in the upper-left and lower-right directions illustrated in FIG. 7D, the activity value determination unit 56 performs comparison between the value located in the upper-left direction and the value located in the lower-right direction among the eight values output by the in-block integration unit 54, and determines the larger one of the two values to be the first activity value.

If the magnitude of the motion vector is zero and thus it is difficult to determine the direction of the motion vector, the activity value determination unit 56 determines the block activity value output by the in-block integration unit 53 to be the first activity value.

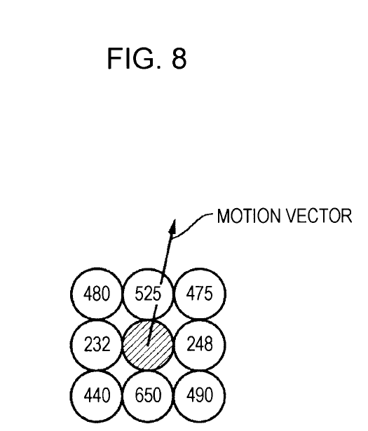

As illustrated in FIG. 8, for example, if the eight values output by the in-block integration unit 54 are represented as 525, 475, 248, 490, 650, 440, 232, and 480 in the clockwise direction starting from the upper direction, and if the direction of the motion vector is included in the upper and lower directions illustrated in FIG. 7B, the value 525 located in the upper direction is compared with the value 650 located in the lower direction, and the larger value 650 is determined to be the first activity value.

Further, on the basis of the determination result of the direction of the motion vector and the output by the directional activity value calculation unit 51, the activity value determination unit 56 determines the first pixel count value by using a pixel number counting unit 57 included therein, and outputs the determined first pixel count value to the subsequent stage.

Specifically, if the direction of the motion vector is included in the upper direction among the total of eight directions, the activity value determination unit 56 compares a predetermined threshold value with the directional activity value located in the upper direction among the eight values for each of the pixels output by the directional activity value calculation unit 51. Then, the activity value determination unit 56 counts the number of pixels, for which the directional activity value located in the upper direction is equal to or larger than the predetermined threshold value, and determines the thus counted number of the pixels to be the first pixel count value.

Similarly, if the direction of the motion vector is included in the lower direction among the total of eight directions, the activity value determination unit 56 compares a predetermined threshold value with the directional activity value located in the lower direction among the eight values for each of the pixels output by the directional activity value calculation unit 51. Then, the activity value determination unit 56 counts the number of pixels, for which the directional activity value located in the lower direction is equal to or larger than the predetermined threshold value, and determines the thus counted number of the pixels to be the first pixel count value.

Similarly, if the direction of the motion vector is included in one of the directions excluding the upper and lower directions among the total of eight directions, the activity value determination unit 56 compares a predetermined threshold value with the directional activity value located in the one of the directions excluding the upper and lower directions among the eight values for each of the pixels output by the directional activity value calculation unit 51. Then, the activity value determination unit 56 counts the number of pixels, for which the directional activity value located in the one of the directions excluding the upper and lower directions is equal to or larger than the predetermined threshold value, and determines the thus counted number of the pixels to be the first pixel count value.

If the magnitude of the motion vector is zero and thus it is difficult to determine the direction of the motion vector, the activity value determination unit 56 compares a predetermined threshold value with the output by the average value calculation unit 52 (the average value of the eight values for each of the pixels output by the directional activity value calculation unit 51). Then, the activity value determination unit 56 counts the number of pixels, for which the output by the average value calculation unit 52 is equal to or larger than the predetermined threshold value, and determines the thus counted number of the pixels to be the first pixel count value.

Therefore, the minimum value of the first pixel count value is zero, and the maximum value of the first pixel count value is the number of the pixels forming the pixel block.

Further, the activity value determination unit 56 determines the second activity value on the basis of the determination result of the direction of the motion vector and the output by the in-block integration unit 54, and outputs the determined second activity value to the subsequent stage.

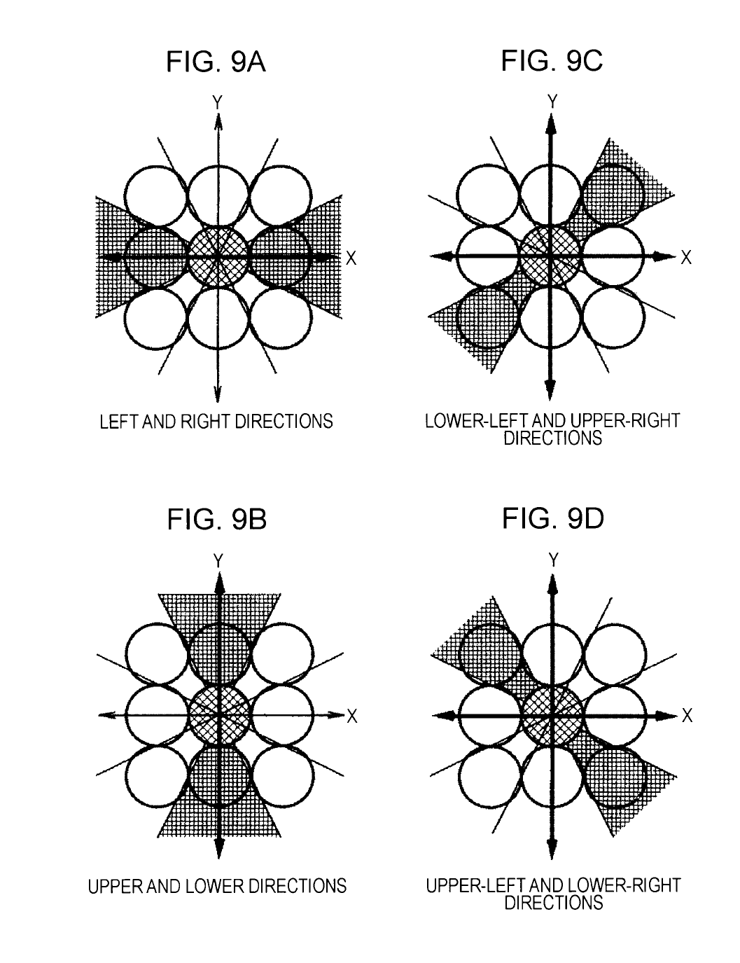

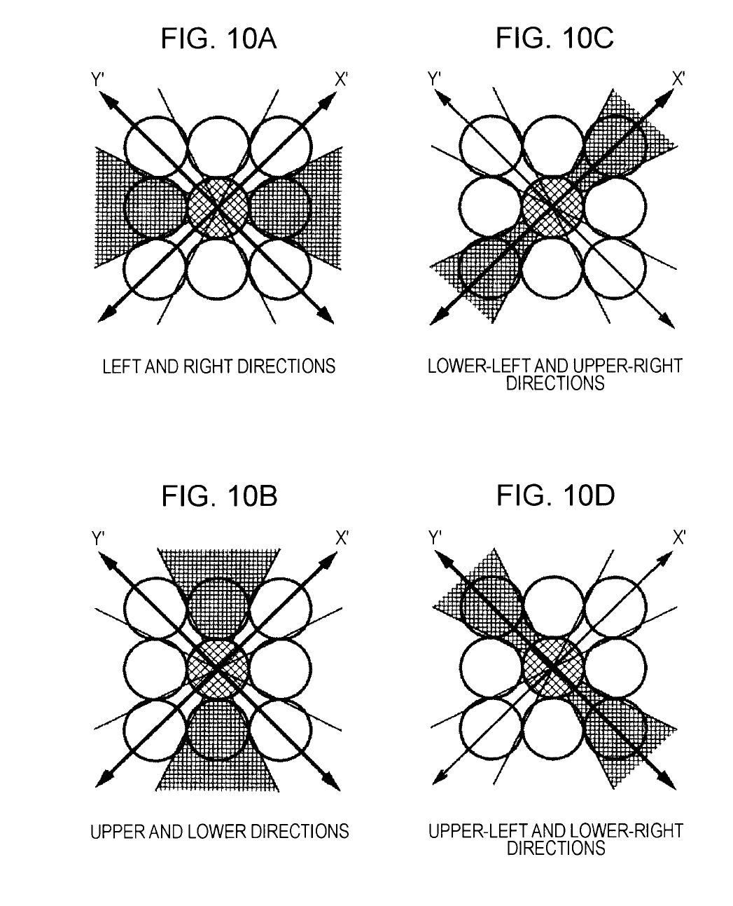

Specifically, the activity value determination unit 56 determines which one of three types of axes, i.e., the X-axis, the Y-axis, and the X- and Y-axes on the X-Y plane illustrated in FIGS. 9A to 9D includes the direction of the motion vector. Further, the activity value determination unit 56 determines which one of three types of axes, i.e., the X′-axis, the Y′-axis, and the X′- and Y′-axes on the X′-Y′ plane illustrated in FIGS. 10A to 10D, which is obtained by rotating the X-axis and the Y-axis of FIGS. 9A to 9D by forty-five degrees in the counterclockwise direction, includes the direction of the motion vector. Then, among the values output by the in-block integration unit 54, the activity value determination unit 56 determines the larger one of the values located in the axis directions including the direction of the motion vector to be the second activity value.

More specifically, if the direction of the motion vector is included in the left and right directions illustrated in FIG. 9A, the activity value determination unit 56 determines that the direction of the motion vector is included in the X-axis on the X-Y plane. Then, among the eight values output by the in-block integration unit 54, the activity value determination unit 56 compares the value located in the left direction with the value located in the right direction, and determines the larger one of the two values to be the second activity value.

If the direction of the motion vector is included in the upper and lower directions illustrated in FIG. 9B, the activity value determination unit 56 determines that the direction of the motion vector is included in the Y-axis on the X-Y plane. Then, among the eight values output by the in-block integration unit 54, the activity value determination unit 56 compares the value located in the upper direction with the value located in the lower direction, and determines the larger one of the two values to be the second activity value.

If the direction of the motion vector is included in the lower-left and upper-right directions illustrated in FIG. 9C or in the upper-left and lower-right directions illustrated in FIG. 9D, the activity value determination unit 56 determines that the direction of the motion vector is included in the X- and Y-axes on the X-Y plane. Then, among the eight values output by the in-block integration unit 54, the activity value determination unit 56 compares the value located in the left direction with the value located in the right direction and the value located in the upper direction with the value located in the lower direction, respectively, and determines the larger one of the value in the left direction and the value in the right direction and the larger one of the value in the upper direction and the value in the lower direction to be the second activity value.

Further, if the direction of the motion vector is included in the left and right directions illustrated in FIG. 10A or in the upper and lower directions illustrated in FIG. 10B, the activity value determination unit 56 determines that the direction of the motion vector is included in the X′- and Y′-axes on the X′-Y′ plane. Then, among the eight values output by the in-block integration unit 54, the activity value determination unit 56 compares the value located in the upper-left direction with the value located in the lower-right direction and the value located in the lower-left direction with the value located in the upper-right direction, respectively, and determines the larger one of the value in the upper-left direction and the value in the lower-right direction and the larger one of the value in the lower-left direction and the value in the upper-right direction to be the second activity value.

If the direction of the motion vector is included in the lower-left and upper-right directions illustrated in FIG. 10C, the activity value determination unit 56 determines that the direction of the motion vector is included in the X′-axis on the X′-Y′ plane. Then, among the eight values output by the in-block integration unit 54, the activity value determination unit 56 compares the value located in the lower-left direction with the value located in the upper-right direction, and determines the larger one of the two values to be the second activity value.

If the direction of the motion vector is included in the upper-left and lower-right directions illustrated in FIG. 10D, the activity value determination unit 56 determines that the direction of the motion vector is included in the Y′-axis on the X′-Y′ plane. Then, among the eight values output by the in-block integration unit 54, the activity value determination unit 56 compares the value located in the upper-left direction with the value located in the lower-right direction, and determines the larger one of the two values to be the second activity value.

If the magnitude of the motion vector is zero and thus it is difficult to determine the direction of the motion vector, the activity value determination unit 56 determines the block activity value output by the in-block integration unit 53 to be the second activity value.

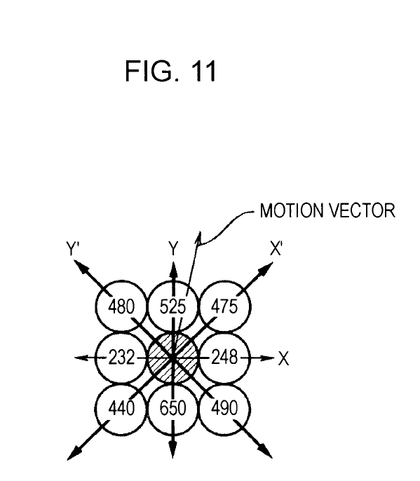

As illustrated in FIG. 11, for example, if the eight values output by the in-block integration unit 54 are represented as 525, 475, 248, 490, 650, 440, 232, and 480 in the clockwise direction starting from the upper direction, the direction of the motion vector is included in the Y-axis on the X-Y plane, as illustrated in FIG. 9B. Therefore, among the eight values output by the in-block integration unit 54, the value 525 located in the upper direction is compared with the value 650 located in the lower direction, and the larger value 650 is determined to be the second activity value. Further, the direction of the motion vector is included in the X′- and Y′-axes on the X′-Y′ plane, as illustrated in FIG. 10B. Therefore, among the eight values output by the in-block integration unit 54, the value 480 located in the upper-left direction is compared with the value 490 located in the lower-right direction, and the value 440 located in the lower-left direction is compared with the value 475 located in the upper-right direction, respectively, and the larger one of the value 480 in the upper-left direction and the value 490 in the lower-right direction and the larger one of the value 440 in the lower-left direction and the value 475 in the upper-right direction, i.e., the values 490 and 475 are determined to be the second activity value.

Further, on the basis of the determination result of the direction of the motion vector and the output by the directional activity value calculation unit 51, the activity value determination unit 56 determines the second pixel count value by using the pixel number counting unit 57 included therein, and outputs the determined second pixel count value to the subsequent stage.

Specifically, the activity value determination unit 56 determines which one of three types of axes, i.e., the X-axis, the Y-axis, and the X- and Y-axes on the X-Y plane illustrated in FIGS. 9A to 9D includes the direction of the motion vector. Further, the activity value determination unit 56 determines which one of three types of axes, i.e., the X′-axis, the Y′-axis, and the X′- and Y′-axes on the X′-Y′ plane illustrated in FIGS. 10A to 10D, which is obtained by rotating the X-axis and the Y-axis of FIGS. 9A to 9D by forty-five degrees in the counterclockwise direction, includes the direction of the motion vector. Then, among the eight values for each of the pixels output by the directional activity value calculation unit 51, the activity value determination unit 56 compares a predetermined threshold value with the value located in the axis direction including the direction of the motion vector. Then, the activity value determination unit 56 counts the number of pixels, for which all of the directional activity values located in the axis direction including the direction of the motion vector are equal to or larger than the predetermined threshold value, and determines the thus counted number of the pixels to be the second pixel count value.

If the magnitude of the motion vector is zero and thus it is difficult to determine the direction of the motion vector, the activity value determination unit 56 compares a predetermined threshold value with the output by the average value calculation unit 52 (the average value of the eight values for each of the pixels output by the directional activity value calculation unit 51). Then, the activity value determination unit 56 counts the number of pixels, for which the output by the average value calculation unit 52 is equal to or larger than the predetermined threshold value, and determines the thus counted number of the pixels to be the second pixel count value.

Therefore, the minimum value of the second pixel count value is zero, and the maximum value of the second pixel count value is the number of the pixels forming the pixel block.

Description will be made referring back to FIG. 5. The activity value comprehensive determination unit 34 determines the reliability of the motion vector by comprehensively using the block activity value, the first activity value, the first pixel count value, the second activity value, and the second pixel count value input by the activity value calculation unit 33, and outputs the determination result to the reliability determination unit 36. In the determination of the reliability of the motion vector, the following first to tenth determination methods, for example, can be employed.

Herein, the first to tenth determination methods performed by the activity value comprehensive determination unit 34 will be described. Predetermined threshold values mentioned in the following description have been preset, and are not necessarily the same as one another.

The first determination method compares the first activity value with a predetermined threshold value, and determines the detected motion vector to be unreliable if the first activity value is equal to or smaller than the predetermined threshold value.

The second determination method compares the second activity value with a predetermined threshold value, and determines the detected motion vector to be unreliable if the second activity value is equal to or smaller than the predetermined threshold value.

The third determination method compares the first pixel count value with a predetermined threshold value, and determines the detected motion vector to be unreliable if the first pixel count value is equal to or smaller than the predetermined threshold value.

The fourth determination method compares the second pixel count value with a predetermined threshold value, and determines the detected motion vector to be unreliable if the second pixel count value is equal to or smaller than the predetermined threshold value.

The fifth determination method is the logical product of the existing determination method and the first determination method. That is, the fifth determination method determines the detected motion vector to be unreliable if the block activity value is equal to or smaller than a predetermined threshold value, and if the first activity value is equal to or smaller than a predetermined threshold value.

The sixth determination method is the logical product of the existing determination method and the second determination method. That is, the sixth determination method determines the detected motion vector to be unreliable if the block activity value is equal to or smaller than a predetermined threshold value, and if the second activity value is equal to or smaller than a predetermined threshold value.

The seventh determination method is the logical product of the existing determination method and the first and second determination methods. That is, the seventh determination method determines the detected motion vector to be unreliable if the block activity value is equal to or smaller than a predetermined threshold value, if the first activity value is equal to or smaller than a predetermined threshold value, and if the second activity value is equal to or smaller than a predetermined threshold value.

The eighth determination method is the logical product of the existing determination method and the third determination method. That is, the eighth determination method determines the detected motion vector to be unreliable if the block activity value is equal to or smaller than a predetermined threshold value, and if the first pixel count value is equal to or smaller than a predetermined threshold value.

The ninth determination method is the logical product of the existing determination method and the fourth determination method. That is, the ninth determination method determines the detected motion vector to be unreliable if the block activity value is equal to or smaller than a predetermined threshold value, and if the second pixel count value is equal to or smaller than a predetermined threshold value.

The tenth determination method is the logical product of the existing determination method and the third and fourth determination methods. That is, the tenth determination method determines the detected motion vector to be unreliable if the block activity value is equal to or smaller than a predetermined threshold value, if the first pixel count value is equal to or smaller a predetermined threshold value, and if the second pixel count value is equal to or smaller than a predetermined threshold value.

Description will be made referring back to FIG. 5. The accuracy value calculation unit 35 calculates the motion vector accuracy value VC on the basis of the evaluation value input by the motion vector detection unit 32 and the block activity value, the first activity value, the first pixel count value, the second activity value, and the second pixel count value input by the activity value calculation unit 33, and outputs the calculated motion vector accuracy value VC to the reliability determination unit 36.

In the calculation of the motion vector accuracy value VC, the following first to third calculation methods, for example, can be employed. Only one of the first to third calculation methods may be employed. Alternatively, two or three of the first to third calculation methods may be employed to calculate two or three values as the motion vector accuracy value VC and output the calculated values to the reliability determination unit 36.

Similarly to the existing calculation method, the first calculation method normalizes the evaluation value by using the block activity value, as in the equation VC=1−(evaluation value/block activity value).

The second calculation method normalizes the evaluation value by using the first activity value, as in the equation VC=1−(evaluation value/first activity value).

The third calculation method normalizes the evaluation value by using the maximum, minimum, or average value of the second activity value, as in the equation VC=1−(evaluation value/maximum, minimum, or average value of second activity value).

Description will be made referring back to FIG. 5. The reliability determination unit 36 determines whether or not the motion vector detected by the motion vector detection unit 32 is reliable, on the basis of the motion vector accuracy value VC calculated by the accuracy value calculation unit 35 and the determination result provided by the activity value comprehensive determination unit 34. If the reliability determination unit 36 receives inputs of a plurality of motion vector accuracy values VC from the accuracy value calculation unit 35, the reliability determination unit 36 determines the ultimate determination result to be the logical product of determinations based on the respective motion vector accuracy values VC.

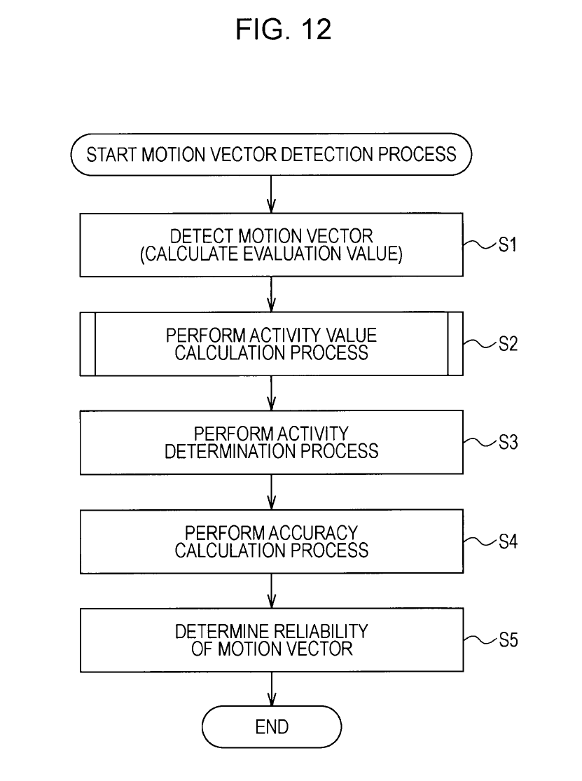

Subsequently, with reference to the flowchart of FIG. 12, description will be made of the motion vector detection process (including the reliability determination of the detected motion vector) performed by the motion vector detection apparatus 30. The motion vector detection process is performed on each of the frames of the image signals input by the preceding stage.

At Step S1, the motion vector detection unit 32 detects the motion vector by employing the block matching method, for example. Specifically, the motion vector detection unit 32 sets the base frame to be one of the two frames of the frame supplied by the preceding stage of the motion vector detection apparatus 30 and the frame supplied by the frame memory 31, divides the frames into the pixel blocks, and detects the motion vector for each of the pixel blocks. Then, the motion vector detection unit 32 supplies the detected motion vector to the not-illustrated subsequent stage and the activity value calculation unit 33, and outputs the evaluation value calculated in the process of detecting the motion vector to the accuracy value calculation unit 35.

At Step S2, the activity value calculation unit 33 divides each of the frames of the image signals into the pixel blocks, and calculates and outputs the block activity value to the activity value comprehensive determination unit 34 and the accuracy value calculation unit 35. Further, the activity value calculation unit 33 calculates and outputs the first activity value, the first pixel count value, the second activity value, and the second pixel count value to the activity value comprehensive determination unit 34.

For convenience of explanation, description has been made in the order of the process of Step S1 and the process of Step S2. However, the process of Step S1 and the process of Step S2 can be performed in parallel.

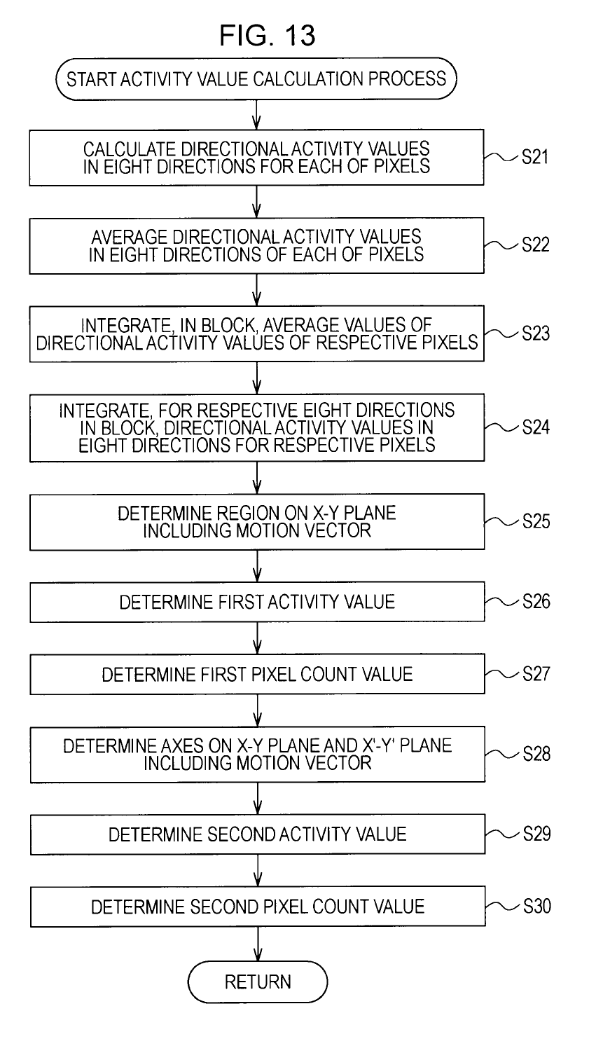

The process of Step S2 will be described in detail with reference to the flowchart of FIG. 13. At Step S21, the directional activity value calculation unit 51 sequentially selects the respective pixels of each of the pixel blocks as the target pixel. Then, the directional activity value calculation unit 51 calculates, as the directional activity values in eight directions, the absolute values of the differences in pixel value between the target pixel and eight pixels adjacent to the target pixel in eight directions of upper, lower, left, right, and diagonal directions, and outputs the calculated directional activity values in eight directions to the activity value determination unit 56. Therefore, the directional activity value calculation unit 51 outputs eight values for each pixel.

At Step S22, the average value calculation unit 52 calculates the average value of the directional activity values in eight directions calculated for each of the pixels by the directional activity value calculation unit 51 (the existing activity value), and outputs the calculated average value to the in-block integration unit 53 and the activity value determination unit 56. Therefore, the average value calculation unit 52 outputs one value for each pixel.

At step S23, the in-block integration unit 53 calculates the in-block total sum (integrated value) of the existing activity values calculated for the respective pixels in the pixel block, i.e., calculates the block activity value, and outputs the calculated block activity value to the activity value determination unit 56. Therefore, the in-block integration unit 53 outputs one value for each pixel block.

At step S24, the in-block integration unit 54 integrates (adds up), for the respective eight directions in the pixel block, the directional activity values in eight directions calculated for the respective pixels, and outputs the integrated values to the activity value determination unit 56. Therefore, the in-block integration unit 54 outputs eight values for each pixel block.

At Step S25, the motion vector direction determination unit 55 determines which one of four types of directions on the X-Y plane illustrated in FIGS. 7A to 7D includes the direction of the motion vector detected in the process of Step S1, and outputs the determination result to the activity value determination unit 56.

At Step S26, the activity value determination unit 56 directly outputs the output by the in-block integration unit 53 to the subsequent stage as the block activity value. Further, the activity value determination unit 56 determines the first activity value on the basis of the determination result of the direction of the motion vector and the output by the in-block integration unit 54, and outputs the determined first activity value to the subsequent stage.

At Step S27, the pixel number counting unit 57 included in the activity value determination unit 56 determines the first pixel count value on the basis of the determination result of the direction of the motion vector and the output by the directional activity value calculation unit 51, and outputs the determined first pixel count value to the subsequent stage.

At Step S28, the motion vector direction determination unit 55 determines which one of three types of axes, i.e., the X-axis, the Y-axis, and the X- and Y-axes on the X-Y plane illustrated in FIGS. 9A to 9D includes the direction of the motion vector detected in the process of Step S1, and outputs the determination result to the activity value determination unit 56. Further, the motion vector direction determination unit 55 determines which one of three types of axes, i.e., the X′-axis, the Y′-axis, and the X′- and Y′-axes on the X′-Y′ plane illustrated in FIGS. 10A to 10D includes the direction of the motion vector detected in the process of Step S1, and outputs the determination result to the activity value determination unit 56.

At Step S29, the activity value determination unit 56 determines the second activity value on the basis of the determination result of the direction of the motion vector and the output by the in-block integration unit 54, and outputs the determined second activity value to the subsequent stage.

At Step S30, the pixel number counting unit 57 included in the activity value determination unit 56 determines the second pixel count value on the basis of the determination result of the direction of the motion vector and the output by the directional activity value calculation unit 51, and outputs the determined second pixel count value to the subsequent stage.

After the block activity value, the first activity value, the first pixel count value, the second activity value, and the second pixel count value have been determined and output as described above, the process returns to Step S3 of FIG. 12.

Referring back to FIG. 12, the activity value comprehensive determination unit 34 determines at Step S3 the reliability of the motion vector by comprehensively using the block activity value, the first activity value, the first pixel count value, the second activity value, and the second pixel count value input by the activity value calculation unit 33, and outputs the determination result to the reliability determination unit 36.

At Step S4, on the basis of the evaluation value input by the motion vector detection unit 32 in the process of Step S1 and the block activity value, the first activity value, the first pixel count value, the second activity value, and the second pixel count value input by the activity value calculation unit 33 in the process of Step S2, the accuracy value calculation unit 35 calculates and outputs the motion vector accuracy value VC to the reliability determination unit 36.

At Step S5, on the basis of the motion vector accuracy value VC calculated by the accuracy value calculation unit 35 in the process of Step S4 and the determination result obtained by the activity value comprehensive determination unit 34 in the process of Step S3, the reliability determination unit 36 ultimately determines whether or not the motion vector detected by the motion vector detection unit 32 is reliable, and outputs the determination result to the subsequent stage. Thereby, the motion vector detection process is completed.

As described above, according to the motion vector detection process performed by the motion vector detection apparatus 30, the reliability of the detected motion vector can be accurately determined. The motion vector detection apparatus 30 can be provided with a circuit size and cost similar to the circuit size and cost of the existing motion vector detection apparatus 10.

The present invention can be applied to an image processing apparatus which performs such processes as a process of compressing and coding a moving image, a process of correcting blurring in a moving image caused by hand shake when the image is taken, a process of detecting a scene change, and a process of estimating the motion of the background, for example.

The sequence of the processes described above can be performed by hardware or software. To have the sequence of the processes performed by software, a program forming the software is installed from a program recording medium on a computer incorporated in special hardware or a general-purpose personal computer, for example, which can perform a variety of functions by installing a variety of programs thereon.

In the program executed by the computer, the processes may be chronologically performed in accordance with the order described in the present specification, or may be performed concurrently or at necessary timing such as upon invocation.

Further, the program may be executed by a single computer, or may be subjected to distributed processing by a plurality of computers. Further, the program may be transferred to and executed by a remote computer.

The embodiments of the present invention are not limited to the embodiments described above, and thus can be modified in a variety of ways within a scope not departing from the gist of the present invention.

What is claimed is:

1. An image signal processing apparatus which detects a motion vector between two temporally successive frames, the image signal processing apparatus comprising:
detection means for detecting the motion vector in pixel blocks between the two frames, and outputting an evaluation value, which represents the degree of correspondence between the two frames in the pixel blocks provided in the two frames, and which is calculated in the process of detecting the motion vector;
calculation means for calculating an activity value, which represents the degree of variation in pixel value in the frame, on the basis of the direction of the detected motion vector; and
arithmetic means for performing an arithmetic operation to obtain an accuracy value, which represents the degree of reliability of the detected motion vector, on the basis of the evaluation value and the activity value.

2. The image signal processing apparatus according to claim 1,
wherein the calculation means calculates plural types of activity values, which represent the degree of variation in pixel value in the frame, on the basis of the direction of the detected motion vector.

3. The image signal processing apparatus according to claim 1, further comprising:
determination means for determining the reliability of the detected motion vector on the basis of the calculated activity value.

4. An image signal processing method performed by an image signal processing apparatus which detects a motion vector between two temporally successive frames, the image signal processing method comprising the steps of:
detecting the motion vector in pixel blocks between the two frames;
outputting an evaluation value, which represents the degree of correspondence between the two frames in the pixel blocks provided in the two frames, and which is calculated in the process of detecting the motion vector;
calculating an activity value, which represents the degree of variation in pixel value in the frame, on the basis of the direction of the detected motion vector; and
performing an arithmetic operation to obtain an accuracy value, which represents the degree of reliability of the detected motion vector, on the basis of the evaluation value and the activity value.

5. A program for controlling an image signal processing apparatus which detects a motion vector between two temporally successive frames, the program causing a computer of the image signal processing apparatus to perform processing comprising the steps of:
detecting the motion vector in pixel blocks between the two frames;
outputting an evaluation value, which represents the degree of correspondence between the two frames in the pixel blocks provided in the two frames, and which is calculated in the process of detecting the motion vector;
calculating an activity value, which represents the degree of variation in pixel value in the frame, on the basis of the direction of the detected motion vector; and
performing an arithmetic operation to obtain an accuracy value, which represents the degree of reliability of the detected motion vector, on the basis of the evaluation value and the activity value.

6. An image signal processing apparatus which detects a motion vector between two temporally successive frames, the image signal processing apparatus comprising:
detection means for detecting the motion vector in pixel blocks between the two frames; and
calculation means for calculating an activity value, which represents the degree of variation in pixel value in the frame, on the basis of the direction of the detected motion vector.

7. The image signal processing apparatus according to claim 6,
wherein the calculation means calculates plural types of activity values, which represent the degree of variation in pixel value in the frame, on the basis of the direction of the detected motion vector.

8. An image signal processing method performed by an image signal processing apparatus which detects a motion vector between two temporally successive frames, the image signal processing method comprising the steps of:
detecting the motion vector in pixel blocks between the two frames; and
calculating an activity value, which represents the degree of variation in pixel value in the frame, on the basis of the direction of the detected motion vector.

9. A program for controlling an image signal processing apparatus which detects a motion vector between two temporally successive frames, the program causing a computer of the image signal processing apparatus to perform processing comprising the steps of:
detecting the motion vector in pixel blocks between the two frames; and
calculating an activity value, which represents the degree of variation in pixel value in the frame, on the basis of the direction of the detected motion vector.

10. An image signal processing apparatus which detects a motion vector between two temporally successive frames, the image signal processing apparatus comprising:
a detection device configured to detect the motion vector in pixel blocks between the two frames, and output an evaluation value, which represents the degree of correspondence between the two frames in the pixel blocks provided in the two frames, and which is calculated in the process of detecting the motion vector;
a calculation device configured to calculate an activity value, which represents the degree of variation in pixel value in the frame, on the basis of the direction of the detected motion vector; and
an arithmetic device configured to perform an arithmetic operation to obtain an accuracy value, which represents the degree of reliability of the detected motion vector, on the basis of the evaluation value and the activity value.

11. An image signal processing apparatus which detects a motion vector between two temporally successive frames, the image signal processing apparatus comprising:
a detection device configured to detect the motion vector in pixel blocks between the two frames; and
a calculation device configured to calculate an activity value, which represents the degree of variation in pixel value in the frame, on the basis of the direction of the detected motion vector.
